(19) United States
(12) Patent Application Publication
(10) Pub. No.: US 2011/0037291 A1
(43) Pub. Date: Feb. 17, 2011

(54) DEVICE FOR IMPROVING A TRACTOR-TRAILER COMBINATION TRUCK AERODYNAMICS AT THE REAR OF THE TRAILER

(75) Inventor: Jay Frederick Pickering, Seattle, WA (US)

Correspondence Address: DAVIS WRIGHT TREMAINE, LLP/Seattle, 1201 Third Avenue, Suite 2200, SEATTLE, WA, 98101-3045, US

(73) Assignee: DRAGGONE AERODYNAMICS, INC., Seattle, WA (US)

(21) Appl. No.: 12/854,042

(22) Filed: Aug. 10, 2010

Related U.S. Application Data
(60) Provisional application No. 61/233,085, filed on Aug. 11, 2009.

(51) Int. Cl. B62D 35/00

(52) U.S. Cl. 296/180.4

(57) ABSTRACT

A device for reducing drag caused by a rear wake of a trailer. The device includes an enclosure supported by support assemblies. The support assemblies include a first corner support extending along a first junction between top and first side portions of the enclosure, a second corner support extending along a second junction between the top portion and a second side portion of the enclosure, a third corner support extending along a third junction between a bottom portion and the second side portion of the enclosure, a fourth corner support extending along a fourth junction between the bottom and first side portions of the enclosure, a first diagonal support extending from the first junction to the third junction, and a second diagonal support extending from the second junction to the fourth junction. The enclosure and support assemblies are coupled to the trailer by a coupling assembly.

### CROSS REFERENCE TO RELATED APPLICATION(S)

This application claims the benefit of U.S. Provisional Application No. 61/233,085, filed Aug. 11, 2009, which is incorporated herein by reference in its entirety.

### BACKGROUND OF THE INVENTION

1. Field of the Invention

The present invention relates generally to devices for reducing air drag experienced by a moving vehicle, and more particularly but not by way of limitation, to devices for reducing an amount of air drag trailing behind a trailer of a tractor-trailer combination truck or van type truck.

2. Description of the Related Art

It is well known that a vehicle, such as a conventional tractor-trailer combination truck having a substantially flat surface along the back of a trailer, experiences a significant amount of air drag at the back of the trailer while traveling along a road or highway. The passage of the vehicle through the atmosphere creates an area of low pressure in the rear wake of the trailer that causes drag on the vehicle and increases both the rate of fuel consumption and the amount of pollution output.

A number of devices have been developed to reduce air drag experienced in the rear wake of the trailer. Examples of such devices are contained in the following patents: U.S. Pat. No. 7,243,980 issued to Vala; U.S. Pat. No. 7,147,270 issued to Andrus and Campbell-Andrus; U.S. Pat. No. 6,959,958 issued to Basford; U.S. Pat. No. 6,854,788 issued to Graham; U.S. Pat. No. 6,666,498 issued to Whitten; U.S. Pat. No. 6,257,654 issued to Boivin and Roberge; U.S. Pat. No. 6,092,861 issued to Whelan; U.S. Pat. No. 5,823,610 issued to Ryan et al.; U.S. Pat. No. 5,947,548 issued to Carpenter and Funderburk; U.S. Pat. No. 5,348,366 issued to Baker and Levitt; U.S. Pat. No. 5,240,306 issued to Flemming; U.S. Pat. No. 4,978,162 issued to Labbe; U.S. Pat. No. 4,818,015 issued to Scanlon; U.S. Pat. No. 4,741,569 issued to Sutphen; U.S. Pat. No. 4,702,509 issued to Elliott; U.S. Pat. No. 4,682,808 issued to Bilanin; U.S. Pat. No. 4,601,508 issued to Kerian; U.S. Pat. No. 4,508,380 issued to Sankrithi; U.S. Pat. No. 4,458,936 issued to Mulholland; and U.S. Pat. No. 4,257,641 issued to Keedy.

A need exists for devices that reduce drag on a vehicle particularly drag experienced in the rear wake of the trailer of a conventional tractor-trailer combination truck. Devices that reduce the rate of fuel consumption and/or pollution output of the truck would be particularly desirable. The present application provides these and other advantages as will be apparent from the following detailed description and accompanying figures.

### BRIEF DESCRIPTION OF THE SEVERAL VIEWS OF THE DRAWING(S)

FIG. 1 is an axonometric elevational view of the device when collapsed and stored in a duffle bag carried by a user before installation.

FIG. 2 is an axonometric elevational view of the device being un-collapsed, un-folded, and installed to a rear portion of a trailer.

FIG. 3 is an axonometric elevational view of pole assemblies being positioned in the device.

FIG. 4 is an axonometric elevational view of a diagonal pole assembly with an internal tension cord being positioned in the device to thereby complete installation of the device on the rear portion of the trailer.

FIG. 5 is a left side elevational view of the device erected and installed on the rear portion of the trailer.

FIG. 6 is a top plan view of the device erected and installed on the trailer.

FIG. 7 is a rear elevational view of the device erected and installed on the rear portion of the trailer.

FIG. 7A is a rear elevational view of the device erected.

FIG. 8 is an enlarged partial view of an upright frame assembly with a hinge and an overtop web strap extending through internal channels formed in upper and intermediate members of the upright frame assembly.

FIG. 9 is an enlarged partial view of the twist latch attachment and the overtop web strap at the top of the upright frame assembly.

FIG. 10 is an enlarged partial view of a corner bracket of the device illustrating the pole assemblies connected to the corner bracket.

FIG. 11 is an enlarged partial view of a lower portion of the upright frame assembly and a portion of an enclosure of the device of FIG. 1.

### DETAILED DESCRIPTION OF THE INVENTION

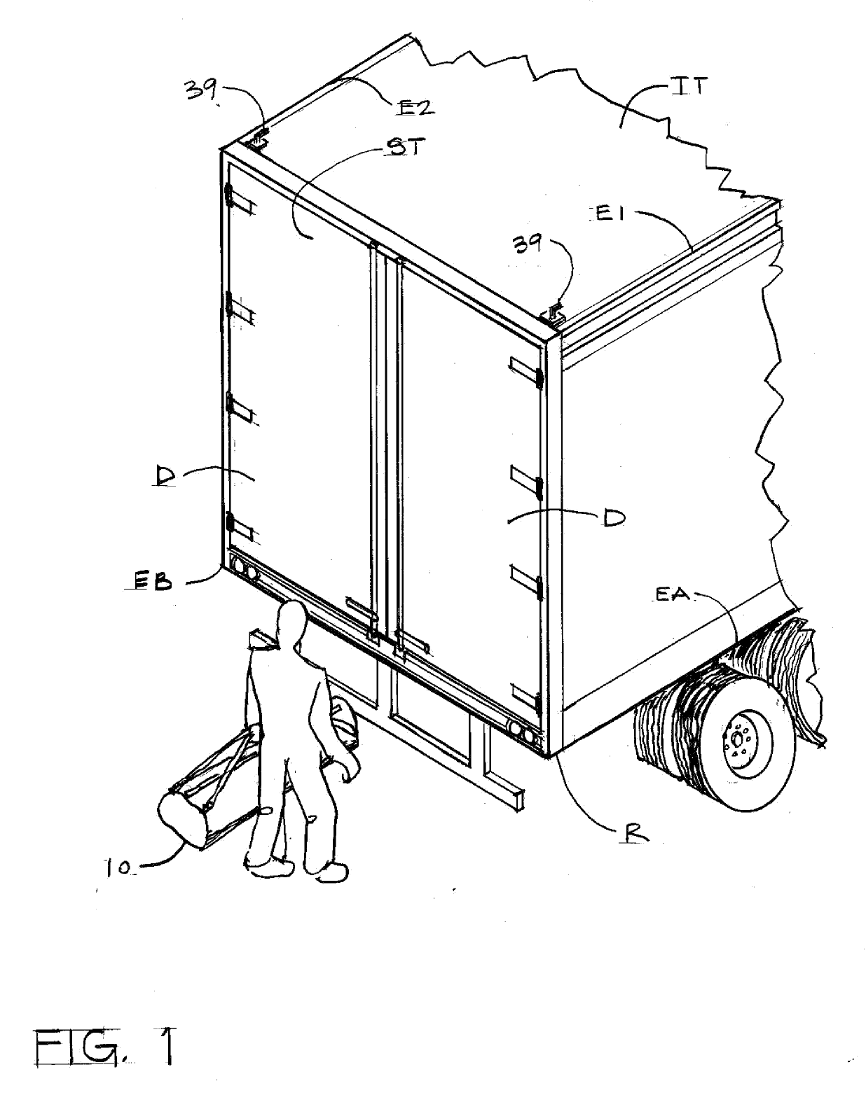

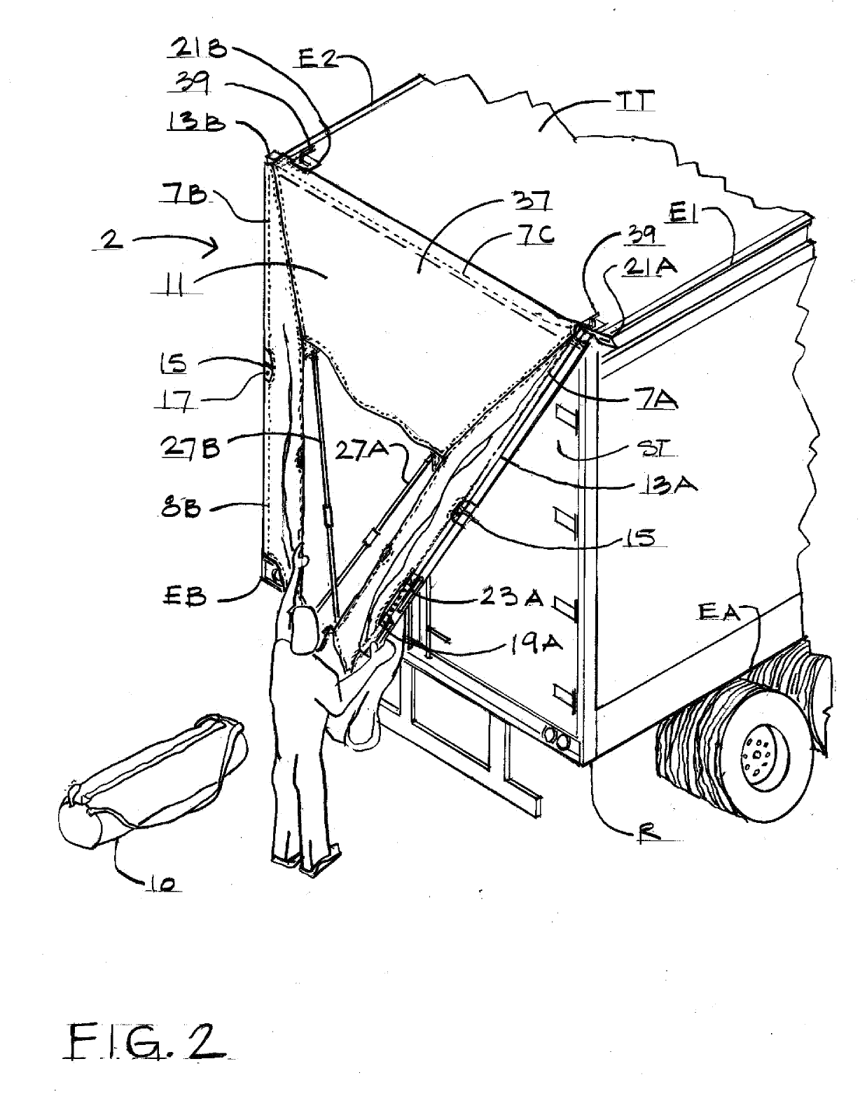

FIG. 1 illustrates a rear portion “R” of a trailer “TT” of a conventional tractor-trailer combination truck (not shown). The trailer “TT” has a substantially flat or planar rearwardly facing surface “ST,” which may be defined along the outside of one or more trailer doors D. Referring to FIG. 2, a device 2 configured to reduce drag resulting from a rear wake (not shown) caused by the rearwardly facing surface “ST” may be stored in a portable carrying container or bag, such as a fabric duffle bag 10. In FIG. 1, the device 2 has been collapsed, folded, and stored in the bag 10. FIG. 1 illustrates a user carrying the bag 10 with the device 2 stored therein to the rear portion “R” of the trailer “TT” before installation. The device 2 may be constructed to be portable for easy relocation from a first trailer to a second trailer for installation on the second trailer.

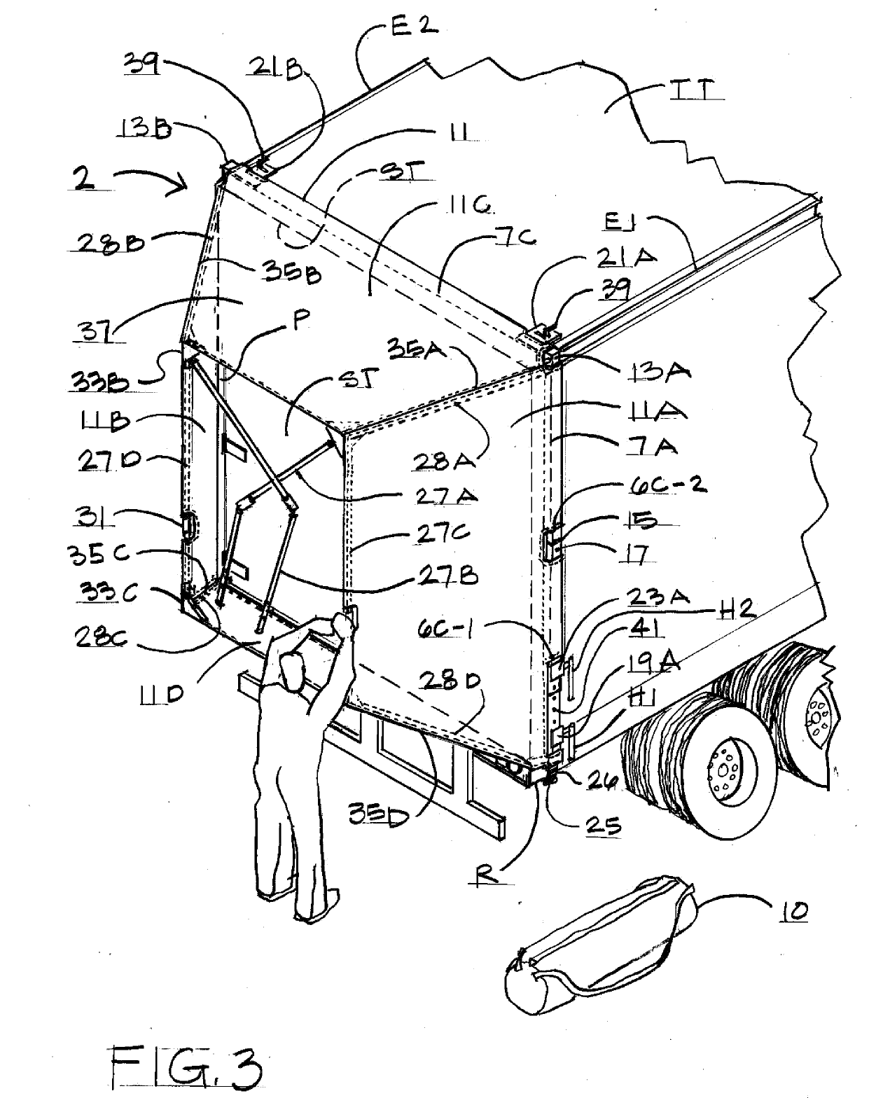

Turning to FIG. 3, the device 2 includes an enclosure 11 that spans and covers a peripheral portion “P” of the rearwardly facing surface “ST” of the trailer “TT.” The enclosure 11 illustrated has a generally tapered or conical shape which is wider along the forward portion of the enclosure adjacent the rear portion “R” of the trailer “TT” and narrower along the rearward portion of the enclosure spaced apart from the rear portion “R” of the trailer “TT.” In the embodiment illustrated, the enclosure 11 tapers gradually and has a general “boat tail” type shape that directs air turbulence away from a low pressure area in the rear wake behind the trailer “TT.” This shape may also reduce air turbulence. In the embodiment illustrated, the enclosure 11 is open along its forward and rear portions.

The enclosure 11 has a first side portion 11A, a second side portion 11B, a top portion 11C, and a bottom portion 11D. In the embodiment illustrated, each of the first side portion 11A, the second side portion 11B, the top portion 11C, and the bottom portion 11D of the enclosure 11 have a generally trapezoidal shape. When assembled, the generally trapezoidally shaped first side portion 11A, second side portion 11B, top portion 11C, and bottom portion 11D form a truncated pyramid shape. The first side portion 11A, the second side portion 11B, the top portion 11C, and the bottom portion 11D are each constructed from a flexible web material, such as fabric 37. It may be desirable for the fabric 37 to have the following properties: low air porosity, high water resistance, high sun and UV resistance, high tear resistance, and high strength. Further, the fabric 37 may be lightweight and highly wind proof. However, it is understood that the first side portion 11A, the second side portion 11B, the top portion 11C, and/or the bottom portion 11D of the enclosure 11 may be constructed from alternate materials and/or fabrics that provide satisfactory performance but have properties and characteristics that vary substantially from those provide above.

Returning to FIG. 2, a first forward loop or sleeve 7A is formed in a forward portion of the first side portion 11A and a second forward sleeve 7B is formed in a forward portion of the second side portion 11B. A forward sleeve 7C is formed in a forward edge portion of the top portion 11C of the enclosure 11. The forward sleeves 7A, 7B, and 7C are each open at both ends.

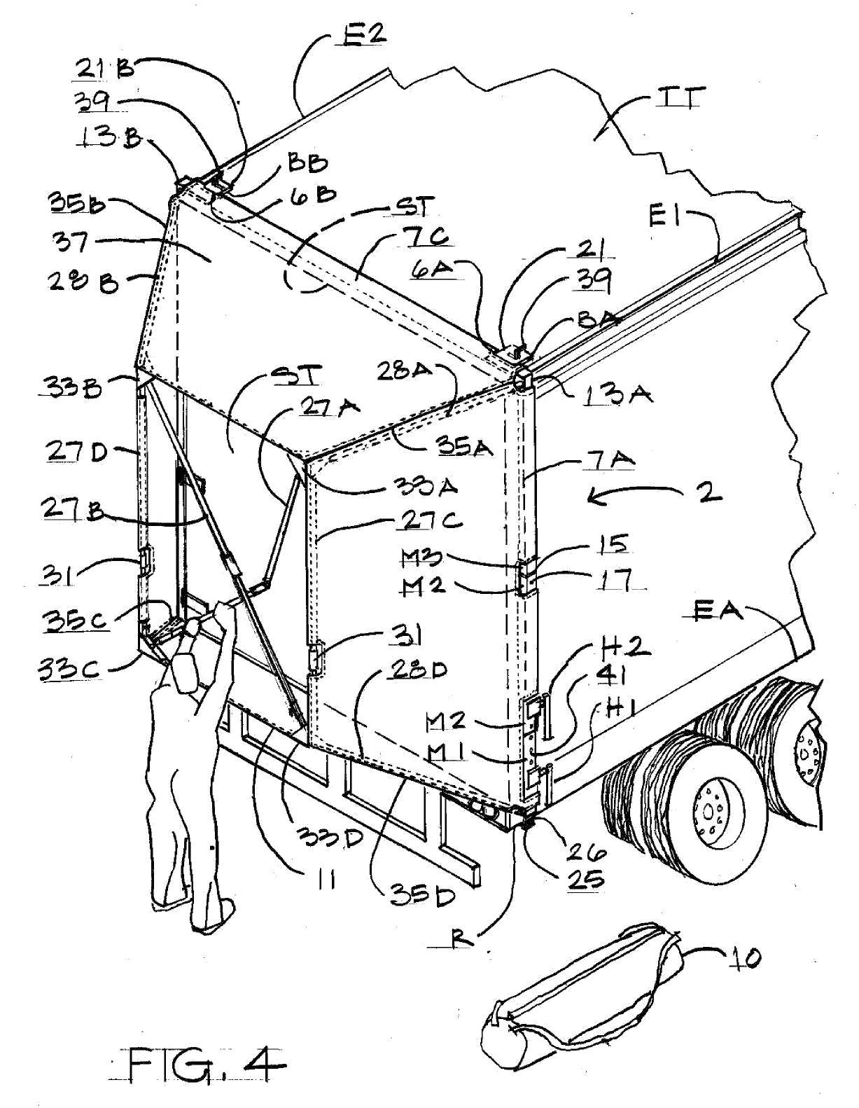

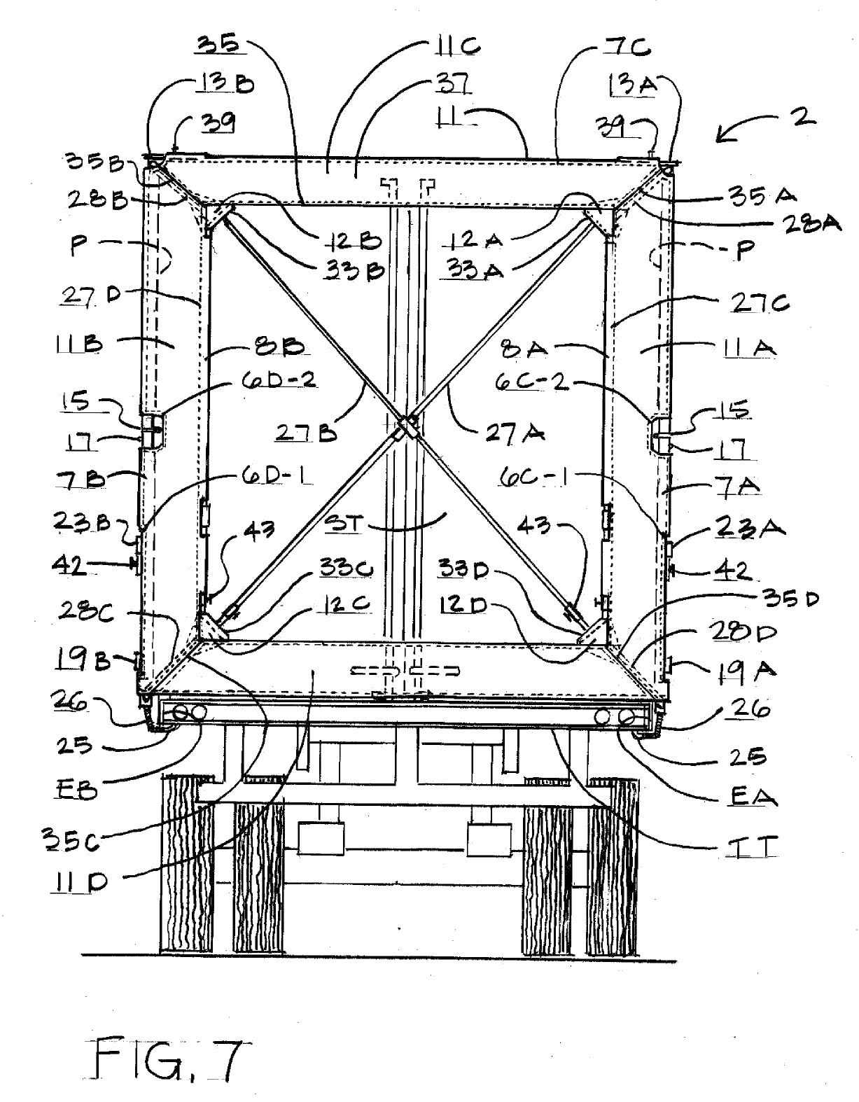

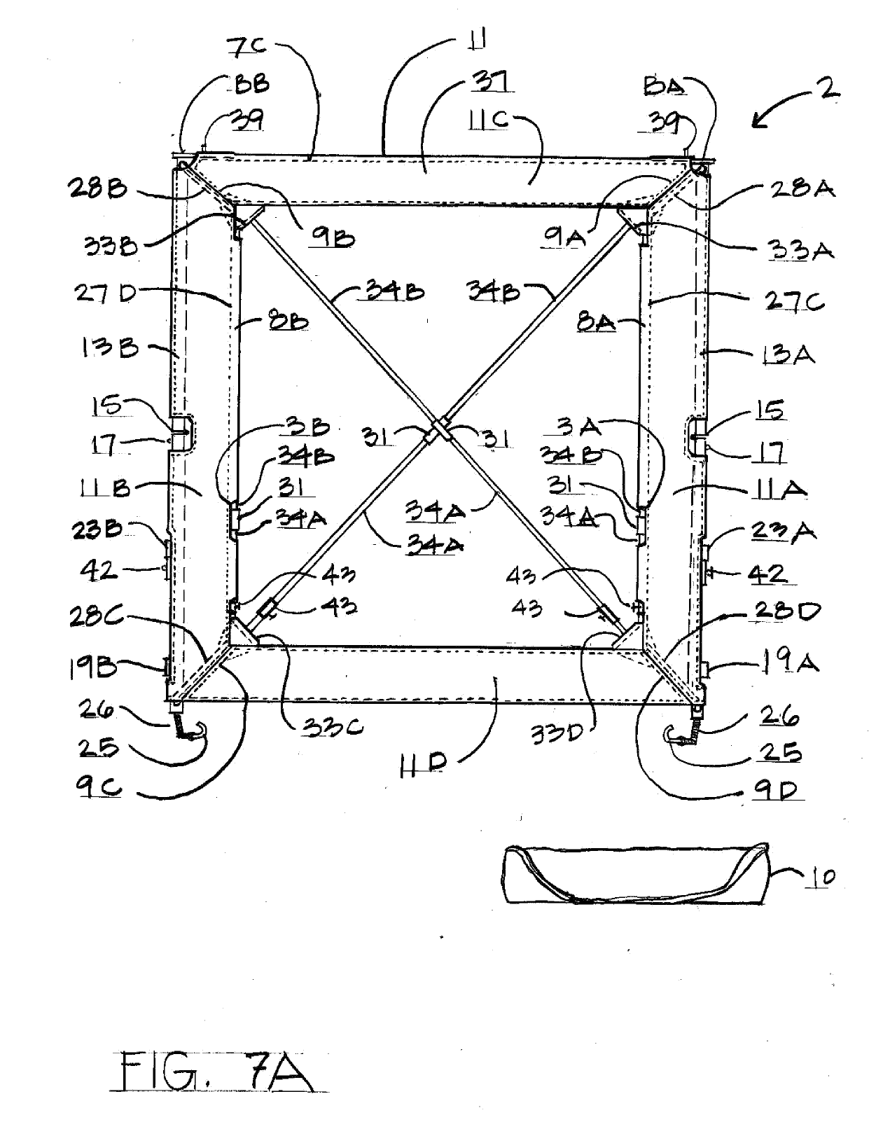

As may best be seen in FIG. 4, the rearward sleeve 7C includes a first opening 6A spaced from the open end adjacent the first side portion 11A and a second opening 6B spaced from the open end adjacent the second side portion 11B. Turning to FIG. 7, the first sleeve 7A includes a lower opening 6C-1 spaced apart from an upper opening 6C-2. The second sleeve 7B includes a lower opening 6D-1 spaced apart from an upper opening 6D-2.

Turning to FIG. 7A, a first rearward loop or sleeve 8A is formed in a rearward portion of the first side portion 11A and a second rearward sleeve 8B is formed in a rearward portion of the second side portion 11B. The rearward sleeves 8A and 8B are each open at both ends. The first rearward sleeve 8A includes an opening 3A and the second rearward sleeve 8B includes an opening 3B.

A first corner sleeve 9A is formed at a first junction between the first side portion 11A and the top portion 11C of the enclosure 11. A second corner sleeve 9B is formed at a second junction between the top portion 11C and the second side portion 11B and of the enclosure 11. A third corner sleeve 9C is formed at a third junction between the second side portion 11B and the bottom portion 11D of the enclosure 11. A fourth corner sleeve 9D is formed at a fourth junction between the bottom portion 11D and the first side portion 11A of the enclosure 11. The corner sleeves 9A-9D may be formed by seams 35A-35D, respectively. The rearward the corner sleeves 9A-9D are each open at both ends.

Turning to FIG. 7, the enclosure may include corner pockets 12A-12D. The first corner pocket 12A is formed along the rearward portion of the first junction between the first side portion 11A and the top portion 11C of the enclosure 11. The first corner pocket 12A has an opening opposite the junction between the first side portion 11A and the top portion 11C of the enclosure 11. The second corner pocket 12B is formed along the rearward portion of the second junction between the top portion 11C and the second side portion 11B and of the enclosure 11. The second corner pocket 12B has an opening opposite the junction between the top portion 11C and the second side portion 11B and of the enclosure 11. The third corner pocket 12C is formed along the rearward portion of the third junction between the second side portion 11B and the bottom portion 11D of the enclosure 11. The third corner pocket 12C has an opening opposite the junction between the second side portion 11B and the bottom portion 11D of the enclosure 11. The fourth corner pocket 12D is formed along the rearward portion of the fourth junction between the bottom portion 11D and the first side portion 11A of the enclosure 11. The fourth corner pocket 12D has an opening opposite the junction between the bottom portion 11D and the first side portion 11A of the enclosure 11.

The device 2 includes a first upright frame assembly 13A and a second upright frame assembly 13B. In the embodiment illustrated, the first frame assembly 13A is positioned inside the first sleeve 7A formed in the forward portion of the first side portion 11A and the second frame assembly 13A is positioned inside the second sleeve 7B formed in the forward portion of the second side portion 11B. Depending upon the implementation details, the sleeves 7A and 7B may be formed by seams stitched or otherwise formed in the fabric 37. Thus, the first and second upright frame assemblies 13A and 13B may be characterized as being seamed inside the first and second side portions 11A and 11B, respectively, of the fabric 37 of the enclosure 11. It is foreseen that the fabric 37 of the enclosure 11 may not require removal from the first and second frame assemblies 13A and 13B, except for maintenance or replacement. However, this is not a requirement. The first and second upright frame assemblies 13A and 13B may be constructed from metal or any other suitable material.

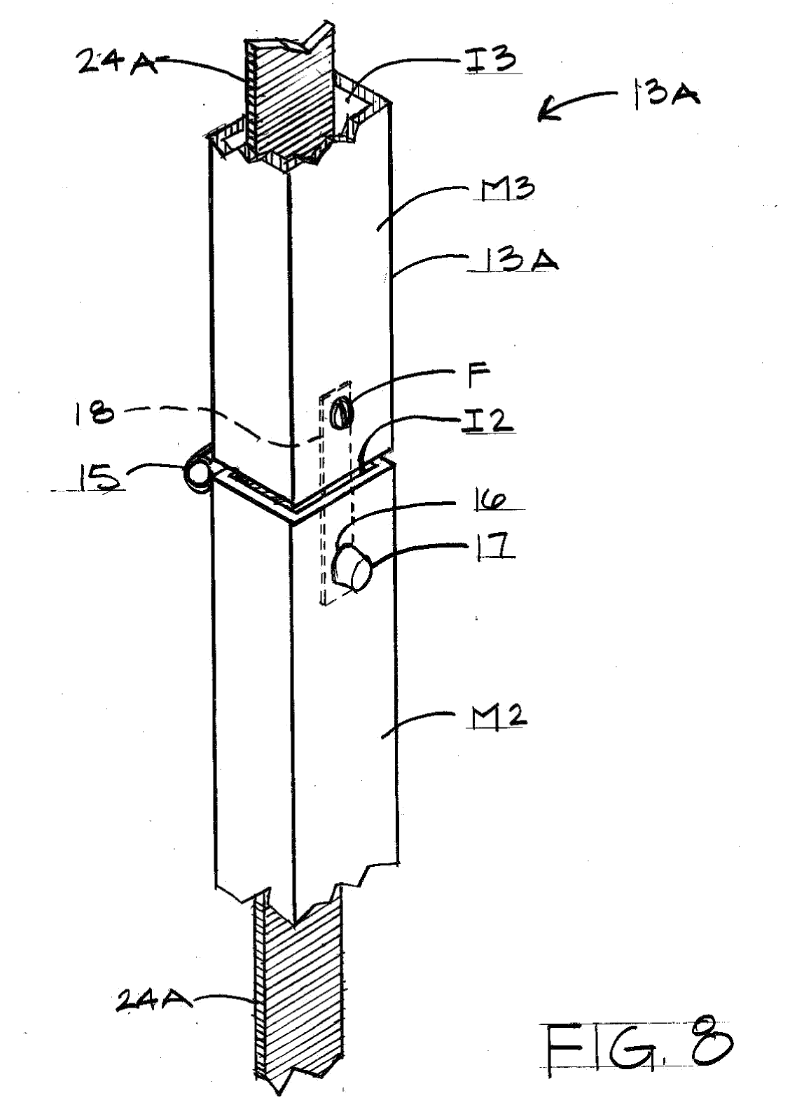

Turning to FIG. 4, each of the first and second upright frame assemblies 13A and 13B may include a lower tube-shaped member “M1,” an intermediate tube-shaped member “M2,” and an upper tube-shaped member “M3.” In each of the first and second upright frame assemblies 13A and 13B, the intermediate member “M2” is hingedly coupled to the upper member “M3” by a hinge 15. The first and second upright frame assemblies 13A and 13B are each configured to fold about the hinge 15. Referring to FIG. 8, when unfolded, each of the first and second upright frame assemblies 13A and 13B may be prevented from pivoting about the hinge 15 by a pin 17 inserted into a slotted hole 16 of a locking member 18. The pin 17 may be implemented as a spring-activated pin that is not removable from the hole 16. The locking member 18 is flexible and may be implemented as a segment of spring steel. The locking member 18 is coupled to the upper member “M3” by one or more fasteners “F.” In FIG. 8, the thumb-spring pin 17 is inserted inside the slotted hole 16 to lock the hinge 15 in the straight unfolded position thereby rendering the first upright frame assemblies 13A substantially rigid and linear. It is also within the scope of the present teachings to provide other collapsing or folding means for collapsing and/or folding the first and second upright frame assemblies 13A and 13B. Further, embodiments in which the first and second upright frame assemblies 13A and 13B do not collapse or fold are within the scope of the present teachings.

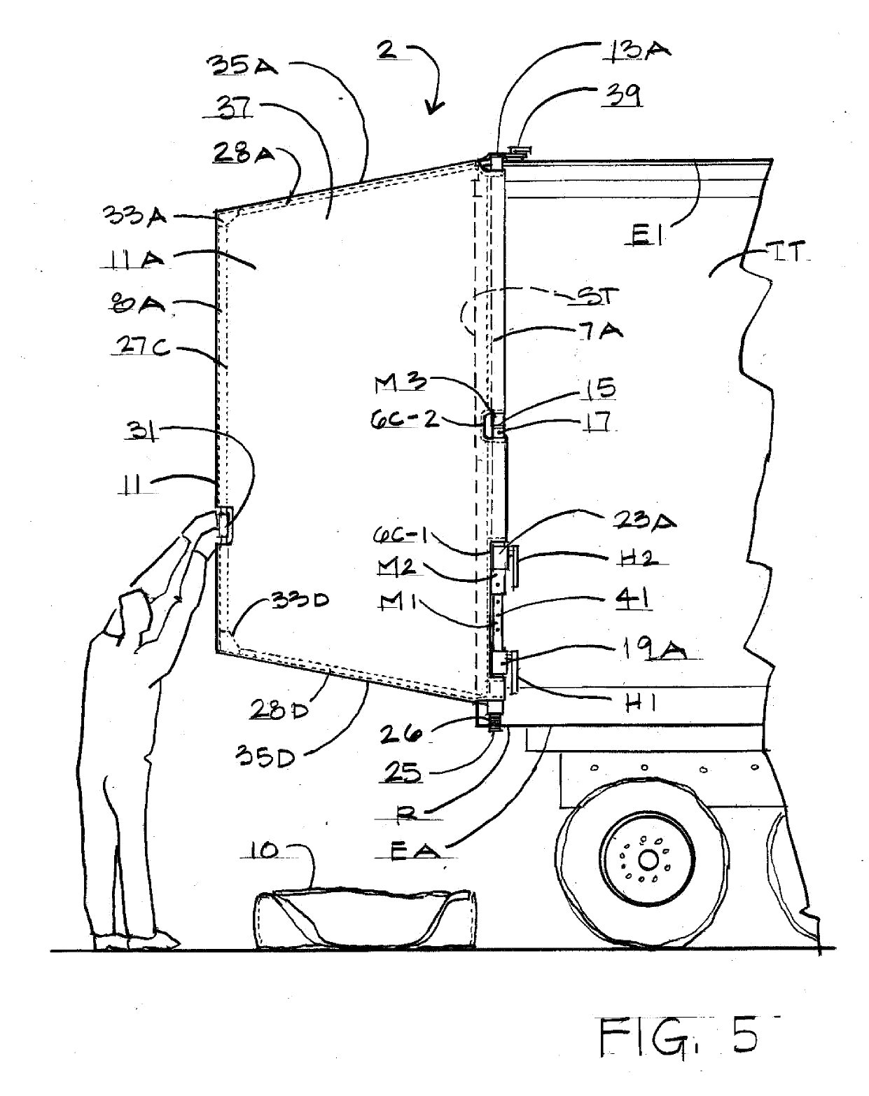

Turning to FIG. 5, with respect to the first side portion 11A of the enclosure 11, to provide access, the hinge 15 and the thumb-spring pin 17 may be positioned inside the upper opening 6C-2 of the sleeve 7A in which the first frame assembly 13A is at least partially received. Turning to FIG. 7, with respect to the second side portion 11B of the enclosure 11, to provide access, the hinge 15 and the thumb-spring pin 17 may be positioned inside the upper opening 6D-2 of the sleeve 7B in which the second frame assembly 13B is at least partially received.

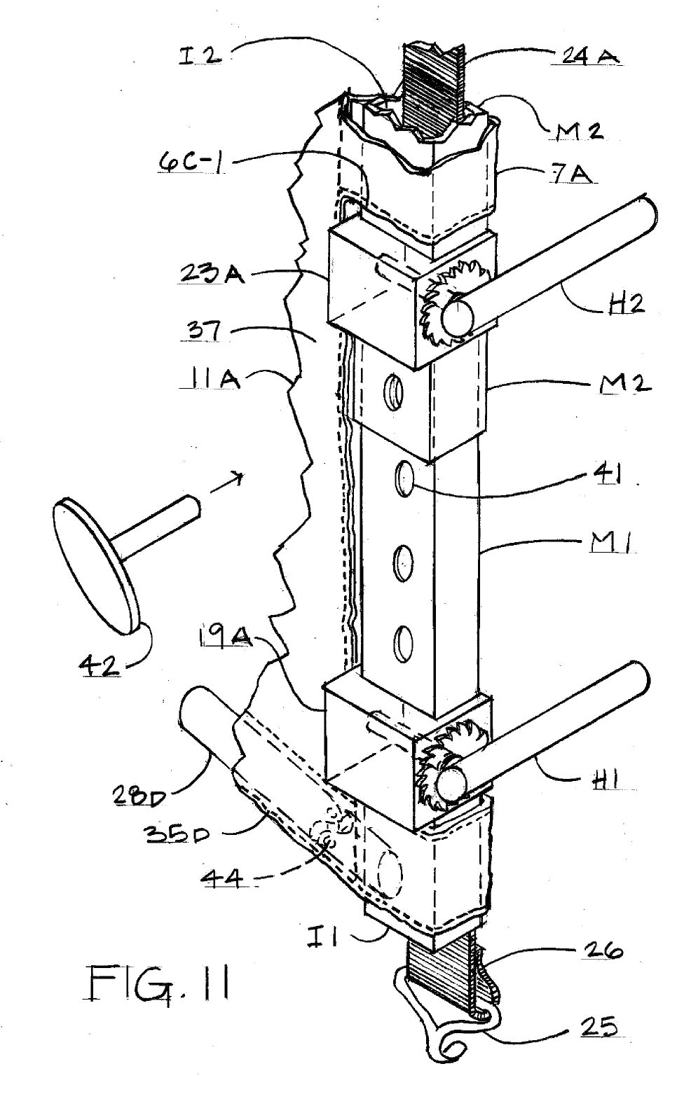

The lower, intermediate, and upper members “M1,” “M2,” and “M3” may each be open at both ends. Turning to FIG. 11, an internal channel “I1” extends between the open ends of the lower member “M1,” an internal channel “I2” extends between the open ends of the intermediate member “M2,” and an internal channel “I3” (see FIG. 8) extends between the open ends of the upper member “M3.” Turning to FIG. 4, the lower and intermediate members “M1” and “M2” are configured telescope to adjust the length of the first and second upright frame assemblies 13A and 13B. In the embodiment illustrated, an upper portion of the lower member “M1” is received inside a lower portion of the intermediate member “M2.” In the embodiment illustrated, the first and second frame assemblies 13A and 13B are adjustable in vertical length with pins 42 (illustrated in FIG. 7) configured to be received inside spaced slotted holes 41 (formed in the lower and intermediate members “M1” and “M2”). Each of the pins 42 may be implemented as a quick-release pin, such as a self-locking quick-release T-pin. Turning to FIG. 11, the length of each of the first and second upright frame assemblies 13A and 13B may be adjusted by aligning a selected one of the holes 41 formed in the intermediate member “M2” with a selected one of the holes 41 formed in the lower member “M1” and inserting a pin 42 through the selected ones of the holes 41 such that the lengths of each of the first and second upright frame assemblies 13A and 13B corresponds to the vertical height dimension of the trailer “TT.” It is also within the scope of the present description to provide alternate means of lengthening (or shortening) the first and second frame assemblies 13A and 13B or to use alternate materials or structures to construct the first and second frame assemblies 13A and 13B.

Turning to FIG. 5, with respect to the first side portion 11A of the enclosure 11, to provide access, the holes 41 may be positioned inside the lower opening 6C-1 of the sleeve 7A in which the first frame assembly 13A is at least partially received. With respect to the second side portion 11B (illustrated in FIG. 7) of the enclosure 11, to provide access, the holes 41 (illustrated in FIG. 5) may be positioned inside the lower opening 6D-1 (illustrated in FIG. 7) of the sleeve 7B (illustrated in FIG. 7) in which the second frame assembly 13B is at least partially received.

Turning to FIG. 7, the first and second frame assemblies 13A and 13B are attached to first and second side portions of the trailer “TT,” respectively. In the embodiment illustrated, each of the first and second frame assemblies 13A and 13B is coupled to the trailer “TT” by a hook 25 coupled to a lower web strap 26. In the embodiment illustrated in FIG. 7, the first frame assembly 13A is coupled to an edge “EA” of the first side portion of the trailer “TT,” by the hook 25 coupled to the lower web strap 26. Similarly, the second frame assembly 13B is coupled to an edge “EB” of the second side portion of the trailer “TT,” by the hook 25 coupled to the lower web strap 26. The first frame assembly 13A is attached to the lower web strap 26 by a lower ratchet 19A, which is configured to tighten the lower web strap 26 causing the hook 25 to bear against the edge “EA” of the first side portion of the truck trailer “TT.” The second frame assembly 13B is attached to the lower web strap 26 by a lower ratchet 19B, which is configured to tighten the lower web strap 26 causing the hook 25 to bear against the edge “EB” of the second side portion of the truck trailer “TT.”

Turning to FIG. 3, each of the ratchets 19A and 19B includes a handle “H1” operable by the user to control the tension applied by the ratchet to the lower web strap 26. Each of the ratchets 19A and 19B may be selectively locked and unlocked. When locked, each of the ratchets 19A and 19B grips the lower web strap 26 engaged with the ratchet. When unlocked, each of the ratchets 19A and 19B releases its grip on the lower web strap 26 engaged with the ratchet. The ratchet 19A may be positioned inside the lower opening 6C-1 of the sleeve 7A in which the first frame assembly 13A is at least partially received. The ratchet 19B may be positioned inside the lower opening 6D-1 of the sleeve 7B in which the second frame assembly 13B is at least partially received.

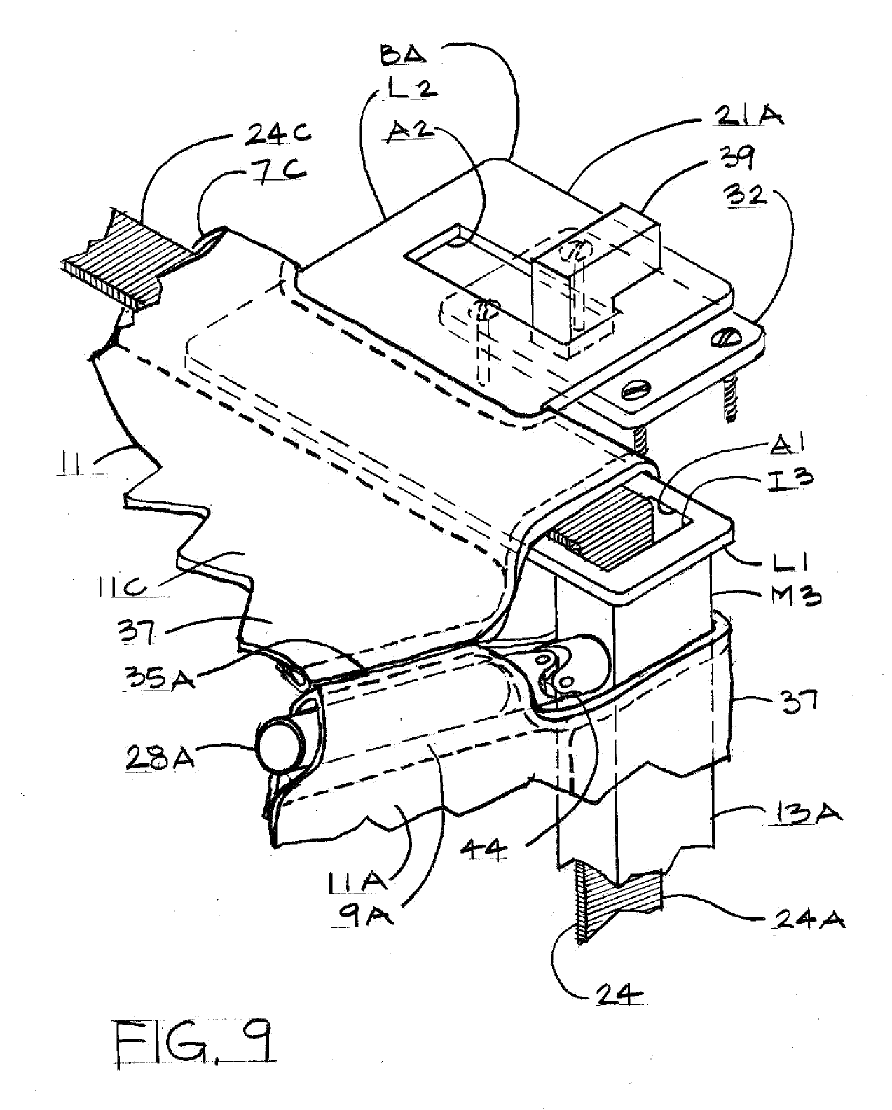

Turning to FIG. 4, the first opening 6A in the rearward sleeve 7C is configured to receive a portion of a first bracket “BA” and the second opening 6B in the rearward sleeve 7C is configured to receive a portion of a second bracket “BB.” Referring to FIG. 9, each of the brackets “BA” and “BB” may be generally L-shaped with a first leg portion “L1” positioned partially inside the rearward sleeve 7C. An aperture “A1” is formed in a distal portion of the first leg portion “L1.” The distal portion of the first leg portion “L1” may extend outwardly from an open end portion of the rearward sleeve 7C. A second leg portion “L2” of each of the first and second brackets “BA” and “BB” extends rearwardly away from the enclosure 11. The second leg portion “L2” includes an aperture “A2” accessible from outside the rearward sleeve 7C.

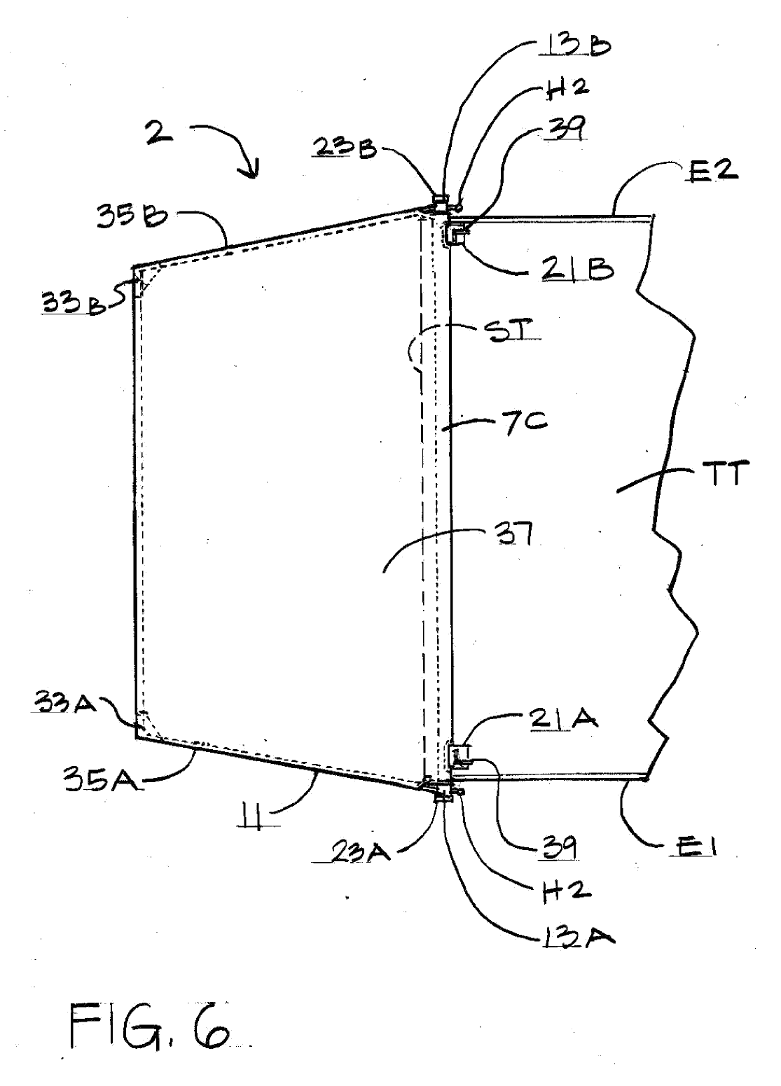

As may best be seen in FIGS. 6 and 9, the device 2 includes an overtop web strap 24 having a first end portion 24A, a second end portion 24B (see FIG. 1A), and an intermediate portion 24C. The second end portion 24B is opposite the first end portion 24A and the intermediate portion 24C is located between the first and second end portions 24A and 24B. Referring to FIG. 9, the first end portion 24A is positioned inside the internal channel “I2” of the intermediate member “M2” of the first frame assembly 13A, and the internal channel “I3” of the upper member “M3” of the first frame assembly 13A, and extends upwardly through the aperture “A1” formed in the first leg portion “L1” of the first bracket “BA.” The intermediate portion 24C is disposed inside the rearward sleeve 7C formed in the rearward portion of the top portion 11C of the enclosure 11. The intermediate portion 24C extends from the aperture “A1” across the top of the first leg portion “L1” of the first bracket “BA” through the rearward sleeve 7C and across the top of the first leg portion “L1” of the second bracket “BB.” The second end portion 24B (see FIG. 6) extends downwardly through the aperture “A1” formed in the first leg portion “L1” of the second bracket “BB” (see FIG. 6) and into the internal channel “I3” of the upper member “M3” of the second frame assembly 13B, and the internal channel “I2” of the intermediate member “M2” of the second frame assembly 13B. The overtop web strap 24 is slidable as a unit relative to the enclosure 11 inside the rearward sleeve 7C, the apertures “A1” of the first and second brackets “BA” and “BB,” the internal channel “I3” of the upper member “M3” of the first frame assembly 13A, the internal channel “I2” of the intermediate member “M2” of the first frame assembly 13A, the internal channel “I3” of the upper member “M3” of the second frame assembly 13B, and the internal channel “I2” of the intermediate member “M2” of the second frame assembly 13B.

Ratchets 23A and 23B are configured to selectively tighten and loosen the overtop web strap 24. The first ratchet 23A is coupled to the first frame assembly 13A and the second ratchet 23B is coupled to the second frame assembly 13B. A portion of the first end portion 24A of the overtop web strap 24 is entwined about the first ratchet 23A, which is configured to selectively tighten and loosen the overtop web strap 24. A portion of the second end portion 24B of the overtop web strap 24 is entwined about the second ratchet 23B, which is configured to selectively tighten and loosen the overtop web strap 24. Each of the ratchets 23A and 23B includes a handle “H2” illustrated in FIG. 5 that is operable by a user to control the tension applied by the ratchet to the overtop web strap 24. Each of the ratchets 23A and 23B may be selectively locked and unlocked. When locked, each of the ratchets 23A and 23B grips the overtop web strap 24. When unlocked, each of the ratchets 23A and 23B releases its grip on the overtop web strap 24. The ratchet 23A may be positioned inside the lower opening 6C-1 of the sleeve 7A in which the first frame assembly 13A is at least partially received. The ratchet 23B may be positioned inside the lower opening 6D-1 of the sleeve 7B in which the second frame assembly 13B is at least partially received.

Twist latches 21A and 21B are coupled to a top portion of the trailer “TT” adjacent to the first side portion of the trailer “TT” and the second side portion of the trailer “TT,” respectively. Referring to FIG. 9, each of the twist latches 21A and 21B includes a bracket 32 configured to be coupled to the top portion of trailer “TT.” By way of a non-limiting example, the bracket 32 may be coupled to the top portion of trailer “TT” by fasteners, such as bolts, screws, and the like. Each of the twist latches 21A and 21B also includes a rotatable key member 39 configured to be received inside one of the apertures “A2” formed in the second leg portions “L2” of the first and second brackets “BA” and “BB.” The rotatable key member 39 is selectively rotatable between a locked position (illustrated in FIGS. 1-7A and 9) and an unlocked position (not shown). By way of a non-limiting example, the rotatable key member 39 may be implemented as a metal J-hook.

When the rotatable key member 39 is in the unlocked position, the rotatable key member 39 may pass through the aperture “A2.” Thus, in this position, the rotatable key member 39 may be received inside or removed from the aperture “A2,” which functions a keyway for the rotatable key member 39. When the rotatable key member 39 of the twist latch 21A is received inside the aperture “A2” of the bracket “BA,” the rotatable key member 39 may be rotated to the locked position to couple the bracket 32 to the bracket “BA.” When the rotatable key member 39 of the twist latch 21A is in the locked position, the rotatable key member 39 may be rotated to the unlocked position allowing the bracket 32 to be disconnected from the bracket “BA.” Similarly, when the rotatable key member 39 of the twist latch 21B is received inside the aperture “A2” of the bracket “BB,” the rotatable key member 39 may be rotated to the locked position to couple the bracket 32 to the bracket “BB.” When the rotatable key member 39 of the twist latch 21B is in the locked position, the rotatable key member 39 may be rotated to the unlocked position allowing the bracket 32 to be disconnected from the bracket “BB.” Thus, the of the twist latches 21A and 21B may be used to selectively couple and uncouple the enclosure 11 to the trailer “TT.”

The first and second frame assemblies 13A and 13B may be easily unattached by unlocking ratchets 19A and 19B to release the tension on the lower web straps 26, unlocking ratchets 23A and 23B to release the tension on the overtop web strap 24, and unlocking twist latches 21A and 21B before the trailer “TT” is disconnected from the tractor (not shown). It is foreseen that the first and second frame assemblies 13A and 13B and the first will not need to be removed from the enclosure 11, except for maintenance or replacement. However, this is not a requirement and the embodiments in which the first and second frame assemblies 13A and 13B are removed from the enclosure 11 for other reasons are within the scope of the present teachings. As is appreciated by those of ordinary skill in the art, alternate means, materials, or structures may be used to couple the first and second frame assemblies 13A and 13B to the trailer “TT” and such alternate means, materials, or structures are within the scope of the present teachings.

The construction of the enclosure 11 and attachment details described for the embodiment depicted in the figures may be configured to allow for rapid and secure attachment of the enclosure 11 to the trailer “TT.” However, it is also understood that a wide variation of the construction, mounting details, and attachment details will not significantly affect the performance of the device 2.

Turning to FIG. 3, in the embodiment illustrated in the drawings, the first frame assembly 13A is attached to the top portion of the trailer “TT” adjacent an upper edge “E1” of the first side portion of the trailer “TT” by the first twist latch 21A and the second frame assembly 13B is attached to the top portion of the trailer “TT” adjacent an upper an edge “E2” of the second side portion of the trailer “TT” by the second twist latch 21B. Turning to FIG. 7, the first frame assembly 13A is also attached to the lower edge “EA” of the first side portion of the trailer “TT” by the hook 25 and the lower web strap 26, which may be selectively tightened (or loosened) by the handle “H1” (see FIG. 3) of the ratchet 19A. The second frame assembly 13B is attached to the lower edge “EB” of the second side portion of the trailer “TT” by the hook 25 and the lower web strap 26, which may be selectively tightened (or loosened) by the handle “H1” of the ratchet 19B. The first and second frame assemblies 13A and 13B are also attached to the trailer “TT” by the overtop web strap 24 that is selectively tightened (or loosened) by the handles “H2” (see FIG. 5) of the ratchets 23A and 23B. It is also within the scope of the present teachings to provide alternate means or structures for attaching the first and second frame assemblies 13A and 13B to the trailer “TT.”

Through application of ordinary skill to the present teachings other shapes, methods, and materials may be used to construct the enclosure 11, the first and second frame assemblies 13A and 13B, and the attachment mechanisms for use with non-rectangularly shaped tractor-trailer combination trucks or other road vehicles.

The construction of the enclosure 11 and the attachment details of the first and second frame assemblies 13A and 13B described for the embodiment illustrated will allow for rapid and secure attachment of the enclosure 11 to the rear portion “R” of the trailer “TT,” as well as the rapid removal of the enclosure 11 from the rear portion “R” of the trailer “TT.” It is foreseen that the device 2 will be unattached from the trailer “TT” when the trailer TT is not in use. However, this is not a requirement.

As discussed above and illustrated in FIG. 3, the first and second frame assemblies 13A and 13B are secured to the top portion of the trailer “TT” by the twist latches 21A and 21B, which include the rotatable key members 39. The twist latches 21A and 21B allow the frame assemblies 13A and 13B to be securely attached adjacent to the upper edges “E1” and “E2,” respectively, of the trailer “TT.” Turning to FIG. 9, the rotatable key members 39 and brackets 32 may be permanently or removably mounted to the top portion of the trailer “TT.” The overtop web strap 24 may be implemented as a continuous strap positioned inside the rearward sleeve 7C, the internal channels “I2” of the intermediate members “M2” of the first and second frame assemblies 13A and 13B, and the internal channels “I3” of the upper members “M3” of the first and second frame assemblies 13A and 13B to allow continuous attachment tensioning around the first and second side portions and the top portion of the trailer “TT” by the ratchets 23A and 23B. It is also within the scope of the present teachings to provide alternate lengthening and attachment means or materials for attaching the first and second frame assemblies 13A and 13B to the trailer “TT.”

The enclosure 11 is configured to be adjustable along its transverse dimension to span the rear portion “R” of the trailer “TT” transversely. This may be achieved by constructing the top portion 11C and the bottom portion 11D of the enclosure 11 from an amount of fabric 37 sufficient to extend across the greatest width (or transverse dimension) of the trailer “TT.” For narrower trailers (having a shorter transverse dimension), the fabric 37 may simply gather together (and optionally form folds) when the overtop web strap 24 is tightened by the ratchets 23A and 23B. As is appreciated by those of ordinary skill in the art, alternate means and structures for adjusting the transverse dimension of the enclosure 11 may be used, including means and structures that also attach the first and second frame assemblies 13A and 13B to the trailer “TT.”

The device 2 includes a first plurality of pole assemblies 27 (e.g., pole assemblies 27A-27D) and a second plurality of pole assemblies 28 (e.g., pole assemblies 28A-28D). After the first and second upright frame assemblies 13A and 13B have been coupled to the trailer “TT,” the enclosure 11 may be un-collapsed and readied to position the pole assemblies 27 and 28.

Each of the pole assemblies 27A-27D is configured to be selectively folded (or collapsed) and unfolded (or un-collapsed) by the user. Optionally, each of the pole assemblies 27A-27D may be configured to have an adjustable length. Each of the pole assemblies 27 is substantially similar to the other pole assemblies. However, the pole assemblies 27A-27D may vary in length with respect to one another depending on their positioning relative to the enclosure 11. Each of the pole assemblies 27 may be implemented as a collapsible engineered composite pole. By way of a non-limiting example, the pole assemblies 27 may be implemented as collapsible engineered fiberglass reinforced poles.

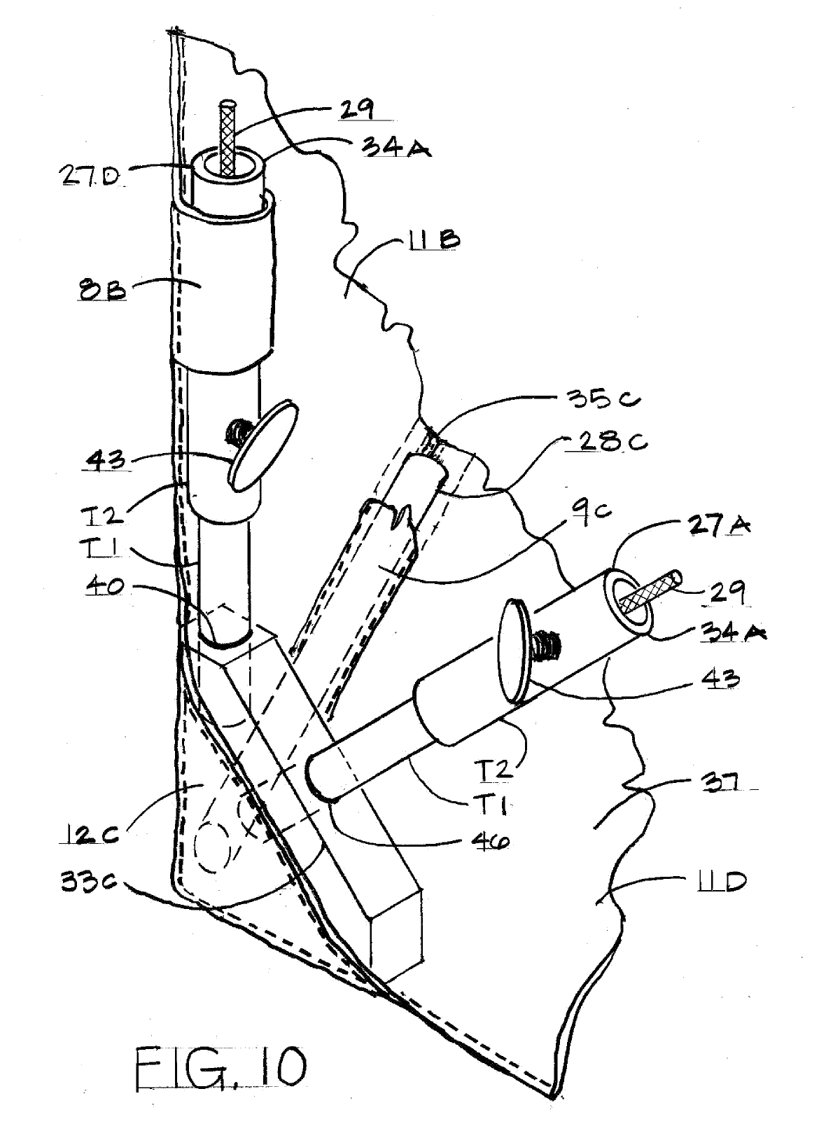

As may be seen in FIG. 7A, each of the pole assemblies 27 has a first generally tube-shaped end portion 34A, a second generally tube-shaped end portion 34B, and an internal tension cord 29 (see FIG. 10) coupling the first end portion 34A to the second end portion 34B and biasing them toward one another.

A coupler 31 may be positioned at the junction between the first and second end portions 34A and 34B. The coupler 31 may be implemented as a metal sleeve. The coupler 31 may overlap the adjacent ends of the first and second end portions 34A and 34B.

In FIG. 7, each of the pole assemblies 27 has been un-collapsed and the adjacent ends of the first and second end portions 34A and 34B connected together by the coupler 31. The internal tension cord 29 (see FIG. 10) helps maintain the adjacent ends of the first and second end portions 34A and 34B inside the coupler 31. Thus, the un-collapsing or unfolding of each of the pole assemblies 27 may be characterized as “snapping” the pole assembly 27 into a substantially linear configuration.

The pole assemblies 27 include a first diagonal pole assembly 27A and a second diagonal pole assembly 27B. In the embodiment illustrated, when unfolded, the first and second diagonal pole assemblies 27A and 27B are arranged diagonally relative to the rear portion “R” (see FIG. 2) of the trailer “TT” and cross one another to form an “X” like shape along a rear portion of the enclosure 11.

The pole assemblies 27 include a first upright pole assembly 27C and a second upright pole assembly 27D. In the embodiment illustrated, when unfolded, the first and second upright pole assemblies 27C and 27D are substantially upright and substantially parallel to one another. The first upright pole assembly 27C is positioned inside the rearward sleeve 8A formed in the rearward portion of the first side portion 11A of the enclosure 11. The coupler 31 may be positioned in the opening 3A formed in the rearward sleeve 8A so that the user may insert adjacent ends of the first and second end portions 34A and 34B into the coupler 31. The second upright pole assembly 27D is positioned inside the rearward sleeve 8B formed in the rearward portion of the second side portion 11B of the enclosure 11. The coupler 31 may be positioned in the opening 3B formed in the rearward sleeve 8B so that the user may insert adjacent ends of the first and second end portions 34A and 34B into the coupler 31. Thus, the first and second upright pole assemblies 27C and 27D may be characterized as being seemed into the enclosure 11.

The lengths of the diagonal and upright pole assemblies 27A-27D may be adjustable. For example, each of the diagonal and upright pole assemblies 27A-27D may be configured to telescope. Turning to FIG. 10, by way of a non-limiting example, the second end portion 34B of each of the diagonal and upright pole assemblies 27A-27D may include an inner tube section “T-1” configured to be partially inserted inside one end of an outer tube section “T-2.” each of the diagonal and upright pole assemblies 27A-27D may include a user operated locking mechanism 43 that when unlocked allows the inner tube section “T-1” to slide within the outer tube section “T-2” thereby allowing the inner tube section to telescope with respect to the outer tube section. On the other hand, when the locking mechanism 43 is locked, the locking mechanism 43 prevents the inner tube section “T-1” from sliding within the outer tube section “T-2.” In the drawings, the locking mechanism 43 has been implemented as a hand operated locking knob (e.g., a threaded tightening wing knob) that when loosened allows telescoping and when tightened prevents further telescoping and maintains the pole assembly at a desired length. By adjusting the lengths of the diagonal and upright pole assemblies 27A-27D, tension may be selectively increased or decreased in the enclosure 11 to thereby expand and/or stiffen the enclosure 11. It is also within the scope of the present teachings to provide other joining means, structures, and/or materials for telescoping and/or locking the length of one or more of the diagonal and upright pole assemblies 27A-27D.

In the embodiment illustrated, each of the pole assemblies 28A-28D is not configured to be collapsed or folded. Further, each of the pole assemblies 28A-28D illustrated has a predetermined or fixed length. However, in alternative embodiments, the lengths of the corner pole assemblies 28A-28D may be adjustable in any manner described above as suitable for adjusting the lengths of the pole assemblies 27. Each of the pole assemblies 28 is substantially similar to the other pole assemblies and may have the same length. Alternatively, the pole assemblies 28A-28D may vary in length with respect to one another depending on their positioning relative to the enclosure 11. Each of the pole assemblies 28 may be implemented as an engineered composite pole. By way of a non-limiting example, the pole assemblies 28 may be implemented as engineered fiberglass reinforced poles.

The pole assemblies 28 include a first corner pole assembly 28A, a second corner pole assembly 28B, a third corner pole assembly 28C, and a fourth corner pole assembly 28D. The first corner pole assembly 28A is positioned in the first corner sleeve 9A formed at the junction of the first side portion 11A and the top portion 11C. The second corner pole assembly 28B is positioned in the second corner sleeve 9B formed at the junction of the top portion 11C and the second side portion 11B. The third corner pole assembly 28C is positioned in the third corner sleeve 9C formed at the junction of the second side portion 11B and the bottom portion 11D. The fourth corner pole assembly 28D is positioned in the fourth corner sleeve 9D formed at the junction of the bottom portion 11D and the first side portion 11A. Thus, the corner pole assemblies 28A-28D may be characterized as being seemed into the enclosure 11. The pole assemblies 28A-28D may be inaccessible inside the corner sleeves 9A-9C, respectively.

The device 2 includes a first corner bracket 33A at the rearward portion of the intersection of the first side portion 11A and the top portion 11C of the enclosure 11. The first corner bracket 33A is positioned inside the first corner pocket 12A. The device 2 includes a second corner bracket 33B at the rearward portion of the intersection of the top portion 11C and the second side portion 11B of the enclosure 11. The second corner bracket 33B is positioned inside the second corner pocket 12B. The device 2 includes a third corner bracket 33C at the rearward portion of the intersection of the second side portion 11B and the bottom portion 11C of the enclosure 11. The third corner bracket 33C is positioned inside the third corner pocket 12C. The device 2 includes a fourth corner bracket 33D at the rearward portion of the intersection of the bottom portion 11D and the first side portion 11A of the enclosure 11. The fourth corner bracket 33D is positioned inside the fourth corner pocket 12D. The corner brackets 33A-33D may be attached to the inside of the corner pockets 12A-12D, respectively, to prevent removal of the brackets from the pockets. However, this is not a requirement. By way of non-limiting examples, the corner brackets 33A-33D may be attached to the inside of the corner pockets 12A-12D, respectively, by grommets, fasteners (such as screws), and the like.

The first diagonal pole assembly 27A extends from the first corner bracket 33A to the third corner bracket 33C. The user inserts a first end of the first diagonal pole assembly 27A into a sleeve 46 (see FIG. 10) (or other type of opening) formed in the first corner bracket 33A. The user inserts a second end of the first diagonal pole assembly 27A (opposite the first end of the first diagonal pole assembly 27A) into a like sleeve 46 (see FIG. 10) (or other type of opening) formed in the third corner bracket 33C. Then, the user couples the adjacent ends of the first and second end portions 34A and 34B of the first diagonal pole assembly 27A together with the coupler 31. The second diagonal pole assembly 27B extends from the second corner bracket 33B to the fourth corner bracket 33D. The user inserts a first end of the second diagonal pole assembly 27B into a sleeve 46 (see FIG. 10) (or other type of opening) formed in the second corner bracket 33B. The user inserts a second end of the second diagonal pole assembly 27B (opposite the first end of the second diagonal pole assembly 27B) into a like sleeve 46 (see FIG. 10) (or other type of opening) formed in the fourth corner bracket 33D. Thus, as illustrated, the first and second diagonal pole assemblies 27A and 27B are inserted into sleeves 46 in the corner brackets 33A-33D coupled to the enclosure 11. Then, the user couples the adjacent ends of the first and second end portions 34A and 34B of the second diagonal pole assembly 27B together with the coupler 31.

Referring to FIG. 7, the corner brackets 33A-33D are substantially identical to one another. However, the orientation of the corner brackets 33A-33D may vary depending upon their positioning along the enclosure 11. The first upright pole assembly 27C extends from the first corner bracket 33A to the fourth corner bracket 33D. The user inserts a first end of the first upright pole assembly 27C into an opening 40 (see FIG. 10) formed in the first corner bracket 33A. The user inserts a second end of the first upright pole assembly 27C (opposite the first end of the first upright pole assembly 27C) into an opening 40 (see FIG. 10) formed in the fourth corner bracket 33D. Then, the user couples the adjacent ends of the first and second end portions 34A and 34B of the first upright pole assembly 27C together with the coupler 31.

The second upright pole assembly 27D extends from the second corner bracket 33B to the third corner bracket 33C. The user inserts a first end of the second upright pole assembly 27D into an opening 40 (see FIG. 10) formed in the second corner bracket 33B. The user inserts a second end of the second upright pole assembly 27D (opposite the first end of the second upright pole assembly 27D) into an opening 40 (see FIG. 10) formed in the third corner bracket 33C. Then, the user couples the adjacent ends of the first and second end portions 34A and 34B of the second upright pole assembly 27D together with the coupler 31.

The first corner pole assembly 28A extends from an upper end portion of the first upright frame assembly 13A to the first corner bracket 33A. A first end of the first corner pole assembly 28A is pivotably coupled to an upper portion of the first upright frame assembly 13A by a connector 44 (see FIG. 9). Thus, the first corner pole assembly 28A may be pivoted by the connector 44 relative to the first upright frame assembly 13A. A second end of the first corner pole assembly 28A (opposite the first end of the first corner pole assembly 28A) is coupled to the first corner bracket 33A. In the embodiment illustrated, the second end of the first corner pole assembly 28A is rigidly connected to the first corner bracket 33A and does not pivot relative thereto.

The second corner pole assembly 28B extends from an upper end portion of the second upright frame assembly 13B to the second corner bracket 33B. A first end of the second corner pole assembly 28B is pivotably coupled to an upper potion of the second upright frame assembly 13B by a connector 44 (see FIG. 9). Thus, the second corner pole assembly 28B may be pivoted by the connector 44 relative to the second upright frame assembly 13B. A second end of the second corner pole assembly 28B (opposite the first end of the second corner pole assembly 28B) is coupled to the second corner bracket 33B. In the embodiment illustrated, the second end of the second corner pole assembly 28B is rigidly connected to the second corner bracket 33B and does not pivot relative thereto.

The third corner pole assembly 28C extends from a lower end portion of the second upright frame assembly 13B to the third corner bracket 33C. A first end of the third corner pole assembly 28C is pivotably coupled to a lower portion of the second upright frame assembly 13B by a connector 44 (see FIG. 9). Thus, the third corner pole assembly 28C may be pivoted by the connector 44 relative to the second upright frame assembly 13B. A second end of the third corner pole assembly 28C (opposite the first end of the third corner pole assembly 28C) is coupled to the third corner bracket 33C. In the embodiment illustrated, the second end of the third corner pole assembly 28C is rigidly connected to the third corner bracket 33C and does not pivot relative thereto.

The fourth corner pole assembly 28D extends from a lower end portion of the first upright frame assembly 13A to the fourth corner bracket 33D. A first end of the fourth corner pole assembly 28D is pivotably coupled to a lower portion of the first upright frame assembly 13A by a connector 44 (see FIG. 9). Thus, fourth corner pole assembly 28D may be pivoted by the connector 44 relative to the first upright frame assembly 13A. A second end of the fourth corner pole assembly 28D (opposite the first end of the fourth corner pole assembly 28D) is coupled to the fourth corner bracket 33D. In the embodiment illustrated, the second end of the fourth corner pole assembly 28D is rigidly connected to the fourth corner bracket 33D and does not pivot relative thereto. The connectors 44 may be implemented as flexible “universal” type connectors or hinges.

It is also within the scope of the present teachings to provide other joining means, structures, and/or materials for attaching the corner pole assemblies 28A and 28D to the first upright frame assembly 13A and/or attaching the pole assemblies 28B and 28C to the second upright frame assembly 13B. It is also within the scope of the present teachings to provide other joining means, structures, and/or materials for stiffening and/or stabilizing the enclosure 11.

In FIG. 10, the ends of diagonal and upright pole assemblies 27A-27D are inserted into the corner bracket 33A-33D. It is also within the scope of the present teachings to provide other joining means, structures, and/or materials for attaching the pole assemblies 27 to the corner brackets 33A-33D.

In FIG. 4, the pole assemblies 27A-27D and the pole assemblies 28A-28D are positioned to fully stiffen and stabilize the enclosure 11 (attached to the rear portion “R” of the trailer “TT” to cover at least a portion of the rearwardly facing surface “ST” of the trailer “TT”).

The shape of the enclosure 11 is defined at least in part by the seams 35A-35D, the first and second upright frame assemblies 13A and 13B, and tension created at least in part by the pole assemblies 27 and 28. The shape of the enclosure 11 may be adjusted to provide a taunt surface over which air can flow to reduce drag caused by a wake trailing behind the trailer “TT” as it travels.

In FIG. 5, the dimensions of the forward portion of the enclosure 11 correspond generally to the dimensions of the rear portion “R” of the trailer TT.

In FIG. 7 and FIG. 7A, the upright frame assemblies 13A and 13B, the pole assemblies 27, and the pole assemblies 28 are configured and arranged to fully deploy and support the enclosure 11. The internal tension cords 29 and couplers 31 allow the pole assemblies 27 to be easily uncollapsed and unfolded. Together the pole assemblies 27 and 28 impart tension and stiffness in the enclosure 11. The first and second diagonal pole assemblies 27A and 27B (inserted into the corner brackets 33A-33D) provide sufficient bracing, rigidity, and stability to the enclosure 11 such that when the enclosure 11 is buffeted by turbulent air flow (e.g., when the trailer “TT” is moving) the enclosure does not collapse against the rearwardly facing surface “ST” of the trailer. It is also within the scope of the present teachings to provide alternate stiffening and flexing means or materials in the enclosure 11. It is foreseen that the pole assemblies 27 will be collapsed and folded each time the device 2 is removed from the trailer “TT.” However, this is not a requirement.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Other modifications and changes may be used in the design and manufacturing of the apparatus of the present invention without departing from the spirit and scope of the accompanying claims.

Accordingly, the invention is not limited except as by the appended claims.

The invention claimed is:

1. A device for use with a trailer having a first longitudinally extending side portion opposite a second longitudinally extending side portion, and a rear portion extending between the first and second side portions, the device comprising:
an enclosure comprising a first side portion, a second side portion opposite the first side portion, a top portion extending between the first and second side portions, and a bottom portion extending between the first and second side portions opposite the top portion, the enclosure further comprising a first junction between the first side portion of the enclosure and the top portion of the enclosure, a second junction between the top portion of the enclosure and the second side portion of the enclosure, a third junction between the second side portion of the enclosure and the bottom portion of the enclosure, and a fourth junction between the bottom portion of the enclosure and the first side portion of the enclosure,
a plurality of support assemblies configured and arranged to support and shape the enclosure, the plurality of support assemblies comprising:
a first corner support assembly extending along the first junction,
a second corner support assembly extending along the second junction,
a third corner support assembly extending along the third junction,
a fourth corner support assembly extending along the fourth junction,
a first diagonal support assembly extending from the first junction to the third junction, and
a second diagonal support assembly extending from the second junction to the fourth junction; and
a coupling assembly configured to couple a forward portion of the top portion of the enclosure, a forward portion of the first side portion of the enclosure, and a forward portion of the second side portion of the enclosure to the rear portion of the trailer.

2. The device of claim 1, wherein the plurality of support assemblies further comprises:
a first upright support assembly extending along a rear portion of the first side portion of the enclosure; and
a second upright support assembly extending along a rear portion of the second side portion of the enclosure.

3. The device of claim 2, further comprising:
a first corner bracket positioned adjacent a rear portion of the first junction, the first corner bracket coupling the first corner support assembly, the first diagonal support assembly, and the first upright support assembly together;
a second corner bracket positioned adjacent a rear portion of the second junction, the second corner bracket coupling the second corner support assembly, the second diagonal support assembly, and the second upright support assembly together;
a third corner bracket positioned adjacent a rear portion of the third junction, the third corner bracket coupling the third corner support assembly, the first diagonal support assembly, and the second upright support assembly together;
a fourth corner bracket positioned adjacent a rear portion of the fourth junction, the fourth corner bracket coupling the fourth corner support assembly, the second diagonal support assembly, and the first upright support assembly together.

4. The device of claim 3, wherein the coupling assembly comprises:
a first upright frame assembly configured to be coupled to the trailer adjacent to the first side portion of the trailer, the first upright frame assembly being coupled to the forward portion of the first side portion of the enclosure, the first corner support assembly being coupled to an upper portion of the first upright frame assembly and extending between the first corner bracket and the upper portion of the first upright frame assembly, and the fourth corner support assembly being coupled to a lower portion of the first upright frame assembly extending between the fourth corner bracket and the lower portion of the first upright frame assembly; and
a second upright frame assembly configured to be coupled to the trailer adjacent to the second side portion of the trailer, the second upright frame assembly being coupled to the forward portion of the second side portion of the enclosure, the second corner support assembly being coupled to an upper portion of the second upright frame assembly and extending between the second corner bracket and the upper portion of the second upright frame assembly, and the third corner support assembly being coupled to a lower portion of the second upright frame assembly and extending between the third corner bracket and the lower portion of the second upright frame assembly.

5. The device of claim 4 for use with a trailer further including a top portion extending between the first and second longitudinally extending side portions, wherein the coupling assembly further comprises:
at least one connector attached to the top portion of the enclosure, the at least one connector being configured to be coupled to the top portion of the trailer, and when coupled thereto to couple the top portion of the enclosure to the top portion of the trailer.

6. The device of claim 1, wherein the enclosure has an open rear portion spaced apart from the rear portion of the trailer.

7. The device of claim 6, wherein the enclosure has an outer shape that tapers from the rear portion of the trailer toward the open rear portion of the enclosure.

8. The device of claim 1, wherein each of the first and second upright support assemblies is configured to be folded and unfolded manually.

9. The device of claim 1, wherein each of the first and second diagonal support assemblies is configured to be folded and unfolded manually.

10. The device of claim 1, wherein each of the first and second upright support assemblies further comprises a length adjustment mechanism configured to adjust the length of the upright support assembly to adjust an amount of tension in the enclosure at least partially imparted therein by the first and second upright support assemblies.

11. The device of claim 1, wherein each of the first and second diagonal support assemblies further comprises a length adjustment mechanism configured to adjust the length of the diagonal support assembly to adjust an amount of tension in the enclosure at least partially imparted therein by the first and second diagonal support assemblies.

12. The device of claim 1 for use with a trailer further including a top portion extending between the first and second longitudinally extending side portions, wherein the coupling assembly comprises a strap having a first end portion coupled to the first side portion of the trailer and a second end portion coupled to the second side portion of the trailer, and
a transverse sleeve is formed in a forward portion of the top portion of the enclosure, the strap extending through the transverse sleeve to draw the forward portion of the top portion of the enclosure toward the top portion of the trailer.

13. The device of claim 12, further comprising at least one ratchet coupled to the strap and configured to impart tension in the strap to draw the forward portion of the top portion of the enclosure toward the top portion of the trailer.

14. The device of claim 1 for use with a trailer further including a top portion extending between the first and second longitudinally extending side portions, wherein a transverse sleeve is formed in the forward portion of the top portion of the enclosure,
a first forward upright sleeve is formed in the forward portion of the first side portion of the enclosure,
a first rearward upright sleeve is formed in a rearward portion of the first side portion of the enclosure,
a second forward upright sleeve is formed in the forward portion of the second side portion of the enclosure,
a second rearward upright sleeve is formed in a rearward portion of the second side portion of the enclosure,
the plurality of support assemblies further comprises a first upright support assembly extending along a rear portion of the first side portion of the enclosure, and a second upright support assembly extending along a rear portion of the second side portion of the enclosure,
the first upright support assembly is positioned inside the first rearward upright sleeve,
the second upright support assembly is positioned inside the second rearward upright sleeve, and
the coupling assembly further comprises:
a first upright member positioned inside the first forward upright sleeve, the first upright member comprising a first open ended upright channel;
a second upright member positioned inside the second forward upright sleeve, the second upright member comprising a second open ended upright channel; and
an upper strap having a first end portion coupled to the first side portion of the trailer and a second end portion coupled to the second side portion of the trailer, the upper strap extending though the first open ended upright channel of the first upright member, the transverse sleeve, and the second open ended upright channel of the second upright member to at least partially couple to the trailer the forward portion of the top portion of the enclosure, the forward portion of the first side portion of the enclosure, and the forward portion of the second side portion of the enclosure.

15. The device of claim 14, wherein the coupling assembly further comprises:
a first ratchet coupled to the first upright member, the first end portion of the upper strap being entwined about the first ratchet, the first ratchet being configured to impart tension in the upper strap;
a second ratchet coupled to the second upright member, the second end portion of the upper strap being entwined about the second ratchet, the second ratchet being configured to impart tension in the upper strap;
a third upright member positioned inside the first forward upright sleeve, the third upright member comprising a third open ended upright channel;
a fourth upright member positioned inside the second forward upright sleeve, the fourth upright member comprising a fourth open ended upright channel; and
a first lower strap having a first end portion opposite a second end portion, the first end portion of the first lower strap being coupled to a lower portion of the first side portion of the trailer, the second end portion of the first lower strap extending upwardly into the third open ended upright channel of the third upright member;
a second lower strap having a first end portion opposite a second end portion, the first end portion of the second lower strap being coupled to a lower portion of the second side portion of the trailer, the second end portion of the second lower strap extending upwardly into the fourth open ended upright channel of the fourth upright member;
a third ratchet coupled to the third upright member, the second end portion of the first lower strap being entwined about the third ratchet, the third ratchet being configured to impart tension in the first lower strap; and
a fourth ratchet coupled to the fourth upright member, the second end portion of the second lower strap being entwined about the fourth ratchet, the fourth ratchet being configured to impart tension in the second lower strap.

16. The device of claim 15, wherein an upper portion of the third upright member is slidably received inside a lower portion of the first upright member, the upper portion of the third upright member being couplable to the lower portion of the first upright member when received therein, and
an upper portion of the fourth upright member is slidably received inside a lower portion of the second upright member, the upper portion of the fourth upright member being couplable to the lower portion of the second upright member when received therein.

17. The device of claim 16, wherein the first end portion of the first lower strap is coupled to the lower portion of the first side portion of the trailer by a first hook, and the first end portion of the second lower strap is coupled to the lower portion of the second side portion of the trailer by a second hook.

18. The device of claim 1 for use with a trailer including a top portion extending between the first and second longitudinally extending side portions, wherein the coupling assembly comprises:
a first upright frame assembly configured to be coupled to a lower edge portion of the first side portion of the trailer, the first upright frame assembly being coupled to the forward portion of the first side portion of the enclosure, the first upright frame assembly comprising an upright member having an upright open-ended internal channel formed therein, the upright open-ended internal channel of the upright member of the first upright frame assembly comprising an open end;
a second upright frame assembly configured to be coupled to a lower edge portion of the second side portion of the trailer, the second upright frame assembly being coupled to the forward portion of the second side portion of the enclosure, the second upright frame assembly comprising an upright member having an upright open-ended internal channel formed therein, the upright open-ended internal channel of the upright member of the second upright frame assembly comprising an open end;
a first connector bracket coupled to the forward portion of the top portion of the enclosure, the first connector bracket having a first through-hole and a first keyway formed therein, the first through-hole being aligned with the open end of the internal channel of the upright member of the first upright frame assembly;
a second connector bracket coupled to the forward portion of the top portion of the enclosure, the second connector bracket having a second through-hole and a second keyway formed therein, the second through-hole being aligned with the open end of the internal channel of the upright member of the second upright frame assembly;
a first latch mechanism configured to be coupled to the top portion of the trailer, the first latch mechanism comprising a rotatable key member configured to be selectively rotatable between a locked position and an unlocked position, when in the unlocked position, the key member being receivable inside the keyway of the first connector bracket, and after being so received, the key member being rotatable to the locked position to couple the first connector bracket to the first latch mechanism;
a second latch mechanism configured to be coupled to the top portion of the trailer, the second latch mechanism comprising a rotatable key member configured to be selectively rotatable between a locked position and an unlocked position, when in the unlocked position, the key member being receivable inside the keyway of the second connector bracket, and after being so received, the key member being rotatable to the locked position to couple the second connector bracket to the second latch mechanism; and
a strap having a first end portion coupled to the first upright frame assembly and the second end portion coupled to the second upright frame assembly, the strap extending through the internal channel of the upright member of the first upright frame assembly, through the first through-hole of the first connector bracket, across a portion of the first connector bracket, across a portion of the second connector bracket, through the second through-hole of the second connector bracket, and through the internal channel of the upright member of the second upright frame assembly.

19. A device for use with a trailer having a rear portion with a rearwardly facing surface, the device comprising:
an enclosure;
means for imparting a shape in the enclosure that at least partially encloses the rearwardly facing surface of the rear portion of the trailer, and has an outer shape configured to direct air flowing over the trailer when the trailer is moving to reduce drag; and
means for coupling a forward portion of the enclosure along the rear portion of the trailer.

20. The device of claim 19, further comprising:
means for shaping the forward portion of the enclosure to substantially conform to a shape of the rear portion of the trailer.
